(19) United States
(12) Patent Application Publication
(10) Pub. No.: US 2001/0034726 A1
(43) Pub. Date: Oct. 25, 2001

(54) Method and system for automating quote generation

(76) Inventors: Terry L. McMahon, Brooklyn Park, MN (US); Michael C. Dovalis, Richfield, MN (US); Michael Fogarty, Eden Prairie, MN (US)

Correspondence Address: SCOTT A MARKS, Dorsey & Whitney LLp, 220 South Sixth Street, Minneapolis, MN, 55402-1498, US

(21) Appl. No.: 09/820,223

(22) Filed: Mar. 28, 2001

Related U.S. Application Data
(60) Provisional application No. 60/193,960, filed on Mar. 31, 2000.

(51) Int. Cl. G06G 7/00; G06F 17/00; G06F 17/60

(52) U.S. Cl. 705/400; 705/26

(57) ABSTRACT

A method for building a specification for leased or purchased equipment. The method comprises electronically soliciting from a user a selection for a generic specification for the equipment, soliciting from the user a manufacturer of one component of the equipment, displaying options and prices for the component and allowing the user to select different options for the component, the act of displaying options and prices including updating the displayed options and prices after an interrelated option has been selected, and generating a report at the client showing the options selected and a subtotal cost for the component.

The present application claims the priority of a U.S. provisional patent application, Serial No. 60/193,960 filed Mar. 31, 2000.

### FIELD

This invention relates to a method and system for automating the generation of specifications and quotes for a pre-engineered vehicle. More particularly, the invention relates to a method and system for automating the generation of specifications and quotes for a vehicle, auto, or equipment lease or purchase. The method and system of the invention may use the Internet and computer hardware and software.

### BACKGROUND

In order to lease or purchase a piece of equipment, such as a vehicle, a customer typically visits a dealer or salesperson of the equipment, details a desired configuration for the equipment, and arranges for certain of the terms of the lease or sale. For many types of equipment, such as heavy duty trucks, hundreds, if not thousands, of configurations can be generated depending on the wishes of the customer and the availability of such options from the manufacturer. Selection among these options may be time consuming for the customer as well as the salesperson.

The salesperson or dealer, who frequently is not an engineer skilled in the design of the equipment, may take notes on the customer's desired configuration and then send via mail, facsimile, or phone, the desired configuration to an engineering unit that is equipped to develop specifications and quotes for varying equipment designs. Because the generation of a specification for many types of equipment can be complex, it is often very difficult for the engineering unit to complete the design for the equipment. Numerous options, for instance, may only be chosen if certain other options are also included, or not included, in the equipment specification. For track specifications, for example, certain transmissions may only be used with certain engines. If the salesperson has improperly selected the options, the quote cannot be properly generated and the whole process is further delayed. A need exists for a method and system of generating quotes from a pre-engineered vehicle that is simple, accurate, and quick to use.

The functions described above are typically carried out through facsimile, mailing, and human processing of documents. Waiting for the return of the information from the engineering department may take a number of days, delaying the development of the specification and quote for a piece of equipment. Supplying the quote to a potential customer after the customer has met or spoken with the salesperson in a time effective manner may be critical to closing some sales or leases. Longer delays in quote generation may result in lost leases or sales, and thus lower profits and productivity.

The typical process outlined above for generating an equipment specification and quote has a number of disadvantages, including time and lost sales. In some instances, sales personnel may attempt to generate specifications and quotes themselves in order to shorten the generation time period and to improve customer relationships. While this may be a limited solution, when more complicated equipment is being purchased, and more interrelated and possible incompatible options are available, these pre-engineered specifications may be modified improperly and may therefore require additional time by the salesperson, and additional interaction with the potential customer and an engineer, to fix. Furthermore, record keeping and statistical analysis of salesperson performance in various terms, such as numbers of sales completed per quote request, may be difficult to evaluate.

A need exists for a method and system for automating the generation of pre-engineered and modified pre-engineered specifications and quotes for a vehicle, auto, or equipment lease and sales that is user friendly, cost and time efficient, and that may be used to generate accurate specifications and quotes. This new system and method should be both quicker and consume less human capital in terms of hours worked. The new system and method may also reduce transaction costs for the lessor/dealer/salesperson, and may therefore lead to additional leases and sales.

### SUMMARY

One embodiment may include a method for building a quote for a piece of equipment comprising displaying one or more pre-engineered specifications for the equipment, electronically soliciting from a user a selection of one pre-engineered specification, soliciting from the user a manufacturer of one component of the equipment, displaying options and prices for the component, and allowing the user to select one or more options for the component, the act of displaying options and prices including updating the displayed options and prices after an interrelated option has been selected, generating a report showing the options selected for the component and a subtotal cost for the component and generating a report showing the components selected and the total cost of the equipment.

A method for building a specification for a track comprising electronically soliciting from a user a selection for a truck class, soliciting from the user a manufacturer of a chassis of the truck, displaying chassis options and prices for the chassis and allowing the user to select one or more chassis options. The act of displaying chassis options and prices may include updating the displayed chassis options and prices after an interrelated chassis option has been selected, calculating a subtotal cost for the chassis, soliciting from the user a manufacturer of a body of the truck, displaying body options and prices for the body and allowing the user to select one or more body options, the act of displaying body options and prices including updating the displayed body options and prices after an interrelated body option has been selected, calculating a subtotal cost for the body of the truck, and a report at the client showing the chassis options selected, the body options selected, and a total cost for the truck.

A method of doing business for generating quotes for leased equipment, the method comprising electronically storing an at least one specification for a piece of equipment on a server, allowing access to the stored specifications by a user, electronically soliciting from the user a selection of one specification stored on the server, displaying to the user one or more options relating to the selected specification, receiving from the user one or more selected options, updating the one or more options relating after each of the one or more options is selected by the user, and displaying to the user a price quote for the selected specification and the selected options.

Another embodiment of the invention is a method for building a specification and quote for leased equipment. The embodiment of the method comprises electronically soliciting from a user a selection for a generic specification for the equipment, soliciting from the user a manufacturer of one component of the leased equipment, displaying options and prices for the component, and allowing the user to select different options for the component. The act of displaying options and prices may include updating the displayed options and prices after an interrelated option has been selected, and generating a quote at the client showing the options selected and a subtotal cost for the component.

Another embodiment of the invention is a method for building a specification for a leased truck. In this embodiment, the method comprises electronically soliciting from a user a selection for a generic specification for the leased truck, soliciting from the user a manufacturer of a chassis of the leased truck, displaying chassis options and prices and allowing the user to select different chassis options, the act of displaying chassis options and prices including updating the displayed chassis options and prices after an interrelated chassis option has been selected, calculating a subtotal cost for the chassis, displaying pre-engineered body options and prices for the body of leased the truck and allowing the user to select different body options, the act of displaying body options and prices including updating the displayed pre-engineered body options and prices after an interrelated body option has been selected, calculating a subtotal cost for the body of the truck, and generating a report at the client showing the chassis options selected, the body options selected, and a total cost for the leased truck.

A customer may request a quote for a specific design based on a series of pre-engineered specifications for portions of the equipment. For example, a number of pre-engineered specifications exist for portions of the design of a truck. The customer may choose a general truck size, a wheel base, an engine, a transmission, and numerous other options for which a pre-engineered specification exists.

### DESCRIPTION OF THE DRAWINGS

FIG. 1 is a block diagram overview of a client-server system in which the present invention may function.

FIG. 2 is a diagram of a web page for a main menu of an embodiment of the invention.

FIG. 3 is a diagram of a web page for displaying a pre-engineered specifications for a first component in one embodiment of the invention.

FIG. 4a is a diagram of a web page displaying one manufacturer's pre-engineered specifications for the first component.

FIG. 4b is a continuation of FIG. 4a which also displays the selectable pre-engineered options for the first component.

FIG. 5 is a diagram of a web page for displaying a pre-engineered specification for a second component for one embodiment of the present invention.

FIG. 6a is a diagram of a web page for displaying information for a specification from a specific manufacturer for the second component.

FIG. 6b is a continuation of FIG. 6a which also displays some of the selectable options for the first component.

FIG. 6c is a continuation of FIG. 6b which also displays the remainder of the selectable options for the first component.

FIG. 7a is a web page for displaying information relating to a pre-engineered specification for an alternative first component.

FIG. 7b is a continuation of FIG. 7a and displays more information for the alternative first component.

FIG. 8a is a web page for displaying information for a pre-engineered specification from a specific manufacturer for the alternative first component.

FIG. 8b is a continuation of FIG. 8a and displays more information about the specific manufacturer's specification, including selectable options.

FIG. 9a is a web page for displaying information relating to a pre-engineered specification for another alternative first component.

FIG. 9b is a continuation of FIG. 9a and displays more information for the alternative first component.

FIG. 10a is a web page for displaying information relating to a pre-engineered specification for another alternative first component.

FIG. 10b is a continuation of FIG. 10a and displays more information for the alternative first component.

FIG. 11a is a web page for displaying information relating to a pre-engineered specification for another alternative first component.

FIG. 11b is a continuation of FIG. 11a and displays more information for the alternative first component.

FIG. 12a is a web page for displaying information relating to a pre-engineered specification for another alternative first component.

FIG. 12b is a continuation of FIG. 12a and displays more information for the alternative first component.

FIG. 13a is a web page for displaying information relating to a pre-engineered specification for another alternative first component.

FIG. 13b is a continuation of FIG. 13a and displays more information for the alternative first component.

FIG. 14a is a web page for displaying information relating to a pre-engineered specification for another alternative first component.

FIG. 14b is a continuation of FIG. 14a and displays more information for the alternative first component.

FIG. 15 is a flowchart illustrating steps of the present invention method.

### DETAILED DESCRIPTION

A. General Overview

The described embodiment of the present invention allows a user, such as a salesperson, to quickly, easily, and accurately build a custom specification and a quote for one piece of equipment. In this embodiment, the user may be allowed to select a generic specification for the leased equipment, select different upfit options for various components of the leased equipment, and then be presented with a subtotal cost for the component of the equipment and/or a total cost for the equipment. Quotes generated by the present invention can be for leased or purchased equipment. The present embodiment description, however, is described in terms of in generating a quote for leased equipment. Various alternative embodiments may allow quote generation for leases or sales, depending on the desires of the customer.

Although different embodiments of the invention are applicable to any type of equipment that may be leased or sold, the specific embodiments of this invention detailed below relate to the design and pricing of vehicles, and more particularly to medium and heavy duty trucks. It should be noted, however, that uses of the methods and systems of the invention may also be applicable to numerous other types of equipment for which specification generation, pre-engineered specifications, and price quoting may be used. Other applications of the invention could include generating specifications and quotes for construction equipment, manufacturing equipment, or vehicle fleets. Any type of equipment that has a number of options available and a number of manufacturers would potentially benefit from the present invention system and method for customizing pre-engineered specifications and automatic quote generation. The present embodiment will be described of generating quotes for leases heavy duty trucks.

Throughout this specification, the term “pre-engineered specification” will be used to refer to the specification for one or more designs of a component for which existing designs have been completed by the lessor (or, in an alternative embodiment, the seller) of the equipment. For example, an engine is one aspect for a truck or car specification for which a variety of designs may exist (a 6 cylinder engine, a V8 engine, a 230 HP engine, etc . . . ). These designs may be pre-engineered to fulfill certain pre-defined needs, such as certain towing capacities or torques. The term pre-engineered specification may encompass any of the design options for the truck, such as exhaust, axles (front and rear), brakes, and other options. These pre-engineered specifications, however, may still allow the customer some options for selection. Options that may be selected may include, for example, the engine, the wheelbase, the type of fuel tanks, transmissions, air conditioning, stereo, etc. The term “specification” may also be used to refer to a completed or partially completed pre-engineered specification for the leased equipment. The term “component” may be used to refer to one or more of the aspects of the leased equipment for which pre-engineered specifications exist. For truck designs, for instance, a first component may be the truck chassis and a second component may be the truck body, each of which may have a number of options that a user may select.

The term “system proprietor” will be used throughout this description to refer to the party that puts forth the present invention system or method for use by a customer or salesperson. The system proprietor may update options, prices, interrelationships between options, and other information in the system. The system proprietor may, in one embodiment, be the lessor of the leased equipment. In an alternative embodiment, the system proprietor may be the seller of the equipment. In still further embodiments, the system proprietor may simply maintain the server and database for another company that actually leases, sells, and pre-engineers the specifications for the equipment.

The present embodiment description utilizes the term “client” to refer to the computer that is entering the present invention system for the downloading of information and the construction of an automatic quote generation. The “salesperson” or the “user” may be the person who is utilizing the client computer to access the present invention. In many instances, both the salesperson/user and the client computer may be referred to by the phrase “user” or “client” when referring to them in such a way that implicates the actions of the salesperson/user through the client computer.

B. Operating System

The present embodiment is described in terms of using a computer as the client connection tool and the world wide web as the information conduit. In alternative embodiments, the present invention method and system may utilize telephones to conduct the automatic quote generation. The telephones may operate using an interactive voice recognition system that presents the user with a series of selectable options that are selected by touching a number on the telephone keypad or by saying a certain number. Such an alternative embodiment may be particularly useful when in embodiments where a fewer number of options may be available for the equipment to be leased or sold.

With regard to references in this specification to computers, the computers may be any standard computer including standard attachments and components thereof (e.g., a disk drive, hard drive, CD player or network server that communicates with a CPU and main memory, a sound board, a keyboard and mouse, and a monitor). The processor of the CPU in the computer may be any conventional general purpose single- or multi-chip microprocessor such as a Pentium® processor, a Pentium® Pro processor, an AMD Athlon, or some other processor known to those skilled in the art. In addition, the processor may be any conventional special purpose processor such as a digital signal processor or a graphics processor. With regard to references to software, the software may be standard software used by those skilled in the art or may be coded in any standard programming language to accomplish the tasks detailed below.

The Internet is widely used today for a variety of applications. The Internet is a collection of computer networks that allows computer users to share files and other computer resources. Each computer connected to the Internet has a unique address whose format is defined by the Internet Protocol (“TCP/IP”).

The system and method of the invention may use the “World Wide Web” (“Web” or “WWW”), which is that collection of servers on the Internet that utilize the Hypertext Transfer Protocol (“HTTP”). HTTP is a known application protocol that provides users access to resources, which may be information in different formats such as text, graphics, images, sound, video, Hypertext Markup Language (“HTML”), as well as programs. Upon specification of a link by the user, the client computer makes a TCP/IP request to a Web server and receives information, which may be another “Web page” that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments of the invention using web pages to allow a user to select options for a given component.

A typical Web page is an HTML document with text, “links” that a user may activate (e.g. “click on”), as well as embedded URL's pointing to resources, such as images, video or sound, that the client may activate to fully use the Web page in a browser. Furthermore, HTTP allows for the transmission of certain information from the client computer to a server. The server can then post this information on its web site, forward it on to another user or server, or save it to a database for later use. The servers of the present embodiment may run on a variety of platforms, including UNIX machines, although other platforms, such as Windows 2000, Windows NT, and Macintosh may also be used. Computer users can view information available on servers or networks on the Web through the use of browsing software, such as Netscape Navigator, Microsoft Internet Explorer, Mosaic, or Lynx browsers.

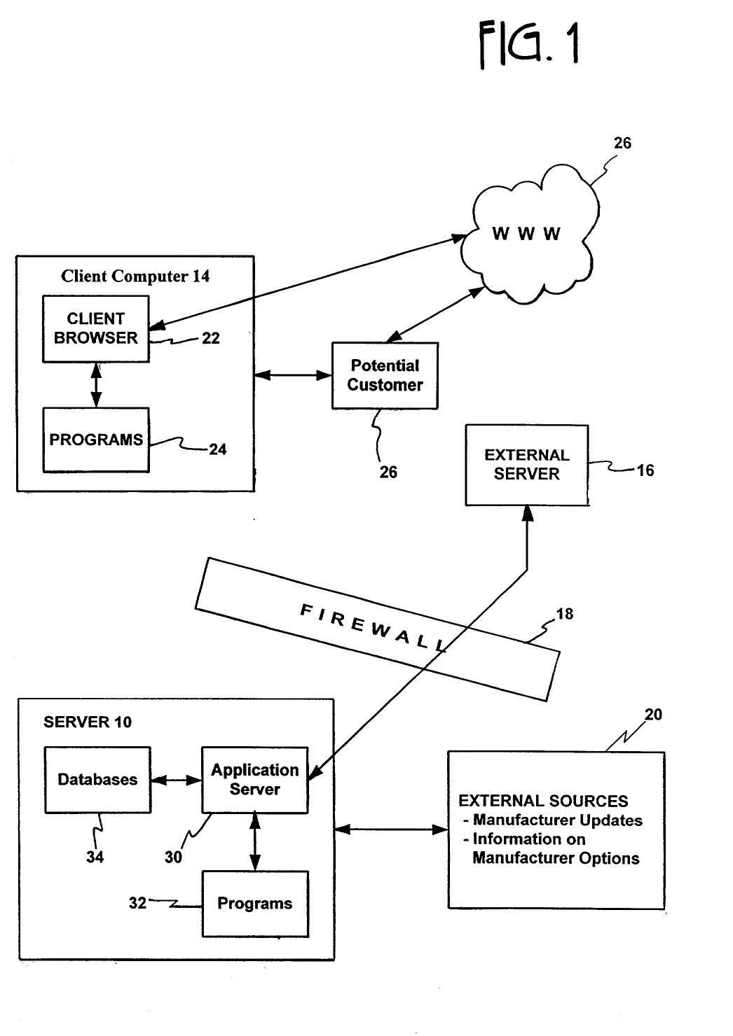

FIG. 1 is a block diagram illustration of the environment of one embodiment of the present invention, which is a network based on a client-server model. The network comprises one or more servers 10 which are accessible by one or more clients 14, such as personal computers or telephones. In FIG. 1, the client 14 may be used by a salesperson or a customer and may be any type of computer system existing at the customer or salesperson's place of business. A salesperson may be an independent salesperson or an employee of the system proprietor. A salesperson or customer, therefore, may access the server 10 from a remote location, such as the salesperson's or customer's office. The server 10 may be one or more computers or computer systems that the system proprietor, such as the lessor of leased equipment, operates. The servers 10 communicate with the clients 14 over a communication path 12, which may be a direct dial connection, Intranet, Extranet, the Internet or World Wide Web (“WWW”) as depicted in FIG. 1, or other suitable telecommunications paths. A suitable network protocol, such as the TCP/IP protocol, may be used for the communications. As previously mentioned, communications may also be done in one embodiment of the invention by voice interactive technology or by pushbutton commands.

The servers 10 may comprise Web servers and application servers, and may be any computer known to those skilled in the art. The Web server and the application server can be separate entities, or may exist within a single computer or computer system. This specification will refer to both possibilities as server 10. The server 10 allows access by the clients 14 to various network resources. FIG. 1 also illustrates an external server 16, which may be a separate computer from the servers 10. In FIG. 1, the external server 16 is separated and protected from the WWW by a firewall 18, which may be any common or custom firewall known to those skilled in the art. The server 10 may also have access, via direct dial or the Internet, to external data sources 20, such as manufacturer web pages or manufacturer programs that may be used to keep the information in the server 10 current. In addition, these manufacturer web pages may be used to provide links so that a salesperson can view options on a manufacturer's web page to assist a potential customer in equipment design. It is to be understood that any number of clients 14 may be connected to the server 10 at any given time, and therefore a number of dealers or salespeople (using clients 14 at remote locations) may access and use the server 10 in order to carry out the invention.

an alternative embodiment, the system proprietor may allow limited access to the customer to the present invention in order to allow for downloading of information relating to an ordered piece of equipment. For example, in one embodiment, the customer can access the system in order to get an order/delivery status update. The customer may also wish to download and/or print the specifications of the specific truck that was ordered. Specification information can also be directly e-mailed or faxed to the customer.

1. The Client-Side

The client computer 14 may be any computer or computers used by those skilled in the art. The client computer 16 comprises a central processor unit (“CPU”) and main memory, an input/output interface for communicating with various databases, files, programs, and networks (such as the Internet), and one or more storage devices. The storage devices may be disk drive devices or CD ROM devices. The client computer may also have a monitor or other screen device and an input device, such as a keyboard or a mouse. In order to carry out the present invention over the Internet, the client computer may also have some software programs 24 contained in the main memory or the storage devices which can be used by the CPU. The software programs 24 on the client computer 14 may also contain other software or programs which may allow the user to fill in information on the screens and to exchange data with the server 10.

In one embodiment of the present invention, a Web browser 22, which is a known software tool used to access the Web via a connection obtained through an Internet access provider, may be part of the software programs on the client computer 14. A variety of browsers known to those skilled in the art may be used within the scope of the present invention, including Netscape Navigator, Microsoft Internet Explorer, or Mosaic browsers. The central processing unit may use the browser software package to interpret the information and display it on a monitor.

FIG. 1 also depicts a potential customer 26. In one embodiment of the invention, the potential customer can communicate with the dealer or salesperson either through a direct dial connection, over the WWW, or through e-mail. The potential customer 26 may provide the dealer or salesperson with information so that a specification and quote may be developed for the customer 26. In other embodiments of the invention, a potential customer may visit a salesperson or dealer directly so that a specification and quote may be developed. In still further embodiments, the salesperson may utilize a phone to talk to the customer while connected to the present invention, the salesperson could then talk through the options with the customer while receiving updated information from the present invention.

2. The Server-Side

FIG. 1 shows a possible server configuration for the system and method of the invention. The server 10 contains software programs 32 that run on the server-side to process requests and responses from the user's interface. In addition, the software programs 32 may send information to the client computer 14, perform compilation and storage functions, generate reports that may be used by either the client or the system proprietor, and carry out the functions of the invention described below through any software packages and methods known to those skilled in the art. If the Internet is the user's interface, then the server 10 may also send web pages in HTML format for the user to download and interpret with his/her computer and view on a monitor.

The server 10 may be set up in a variety of different formats to perform the functions of the invention. In FIG. 1, the server 10 contains an application server 30 to interface with the WWW and a number of databases 34 and programs 32. The databases 34 may contain a variety of information, including various documents that may be used by the system and method of the invention, clients, information on types of equipment, options for equipment, and pricing information. The programs 32 may contain instructions, logic, and software that perform the specification building and quoting for the system and method of the invention as described below.

C. Operation of the Invention

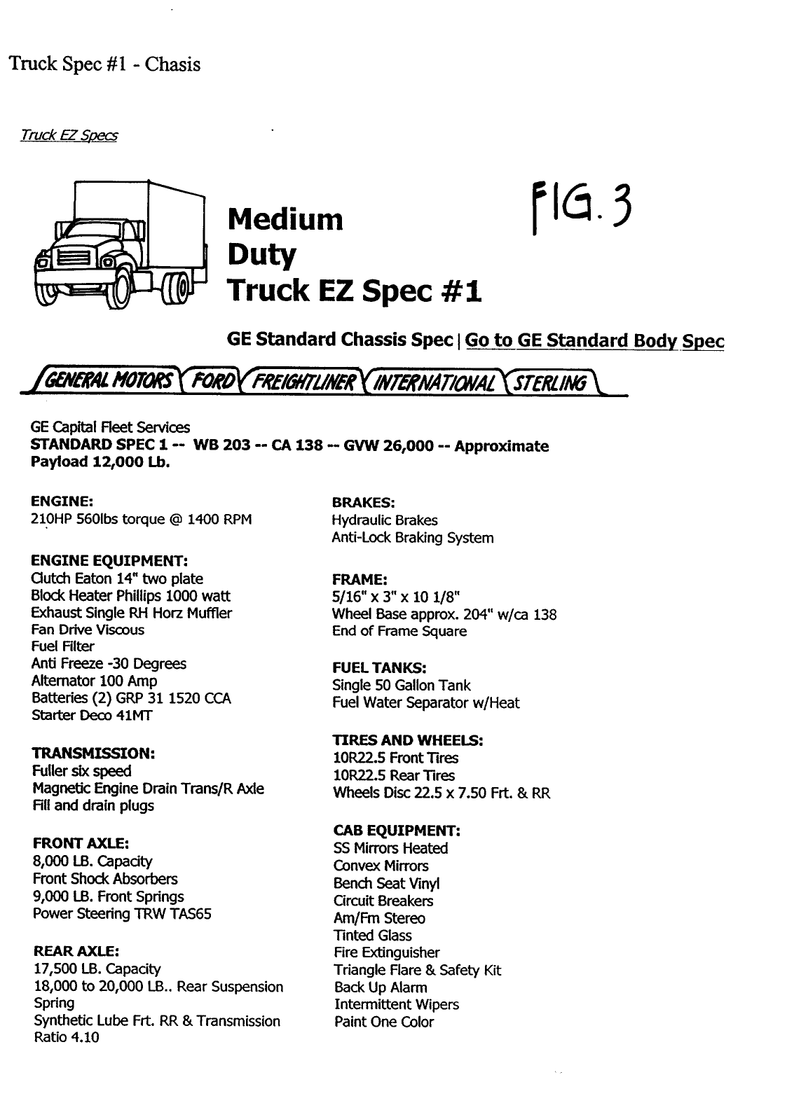

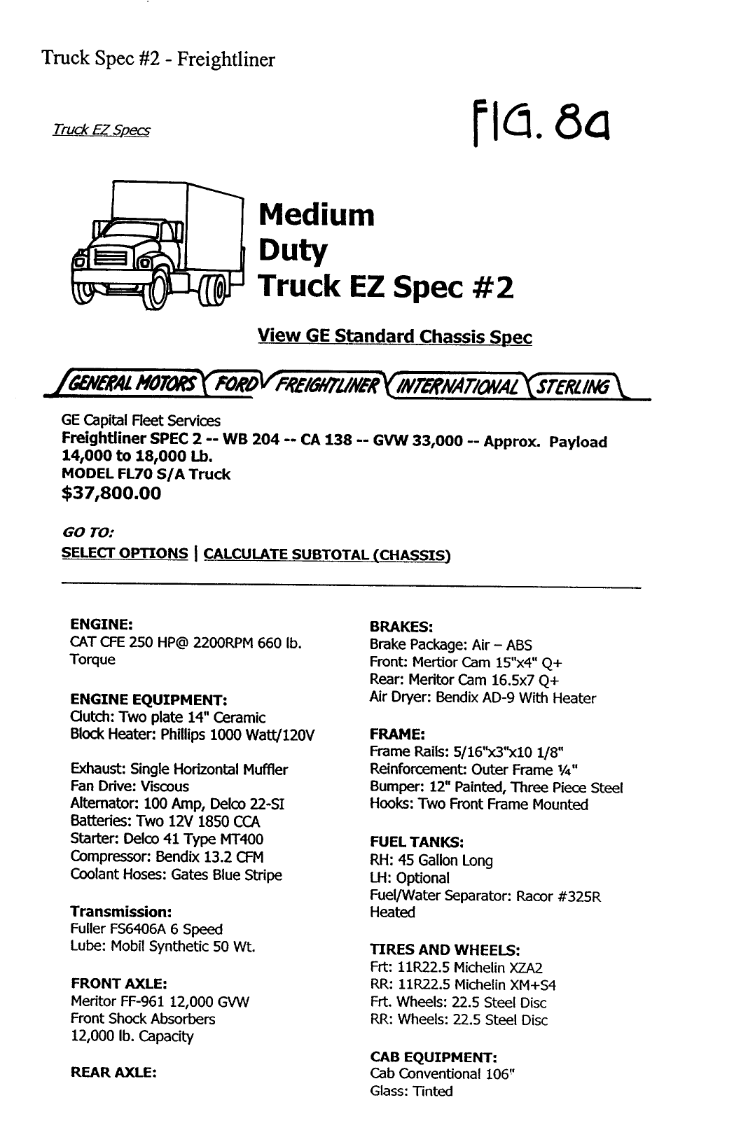

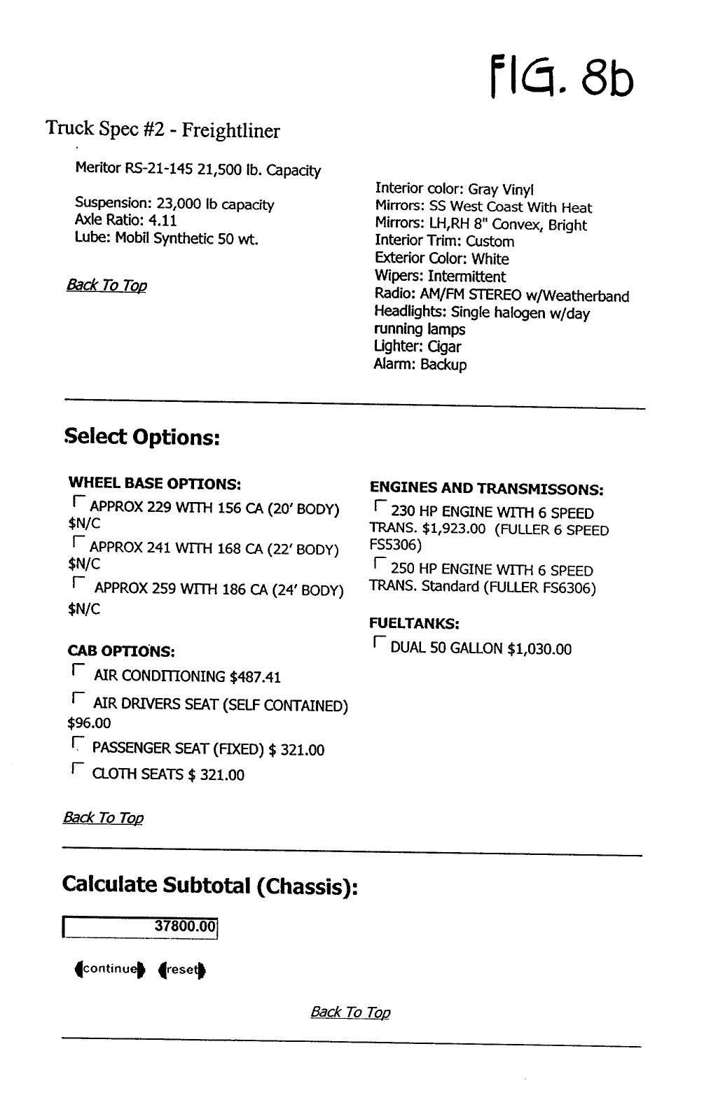

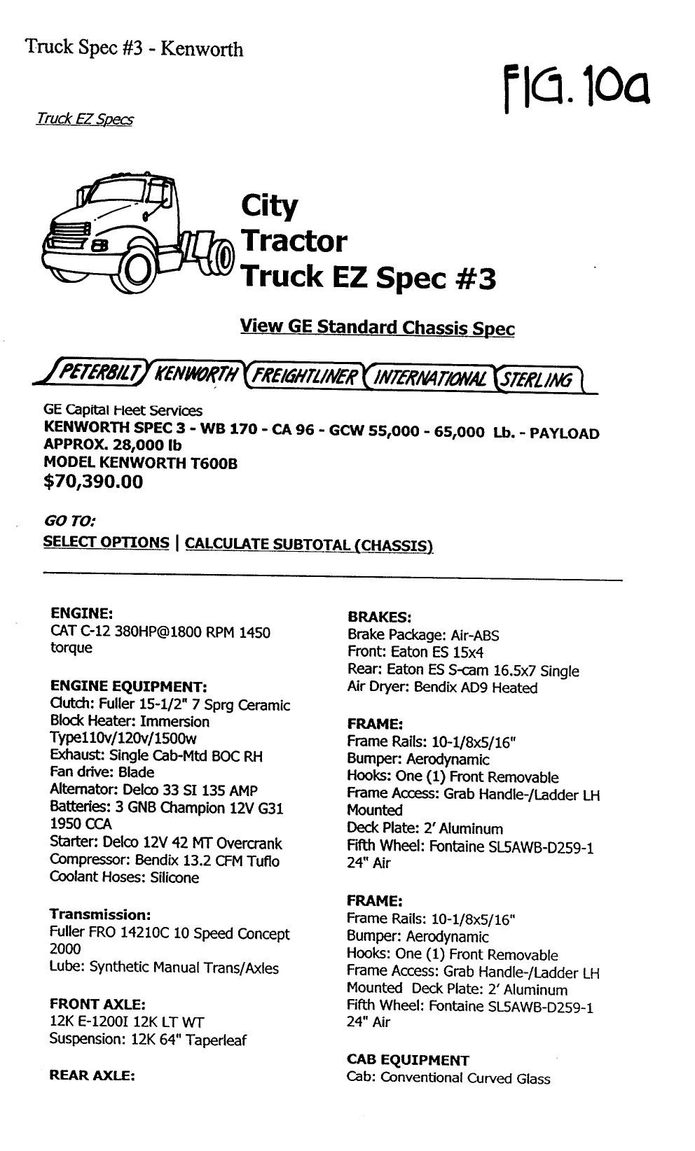

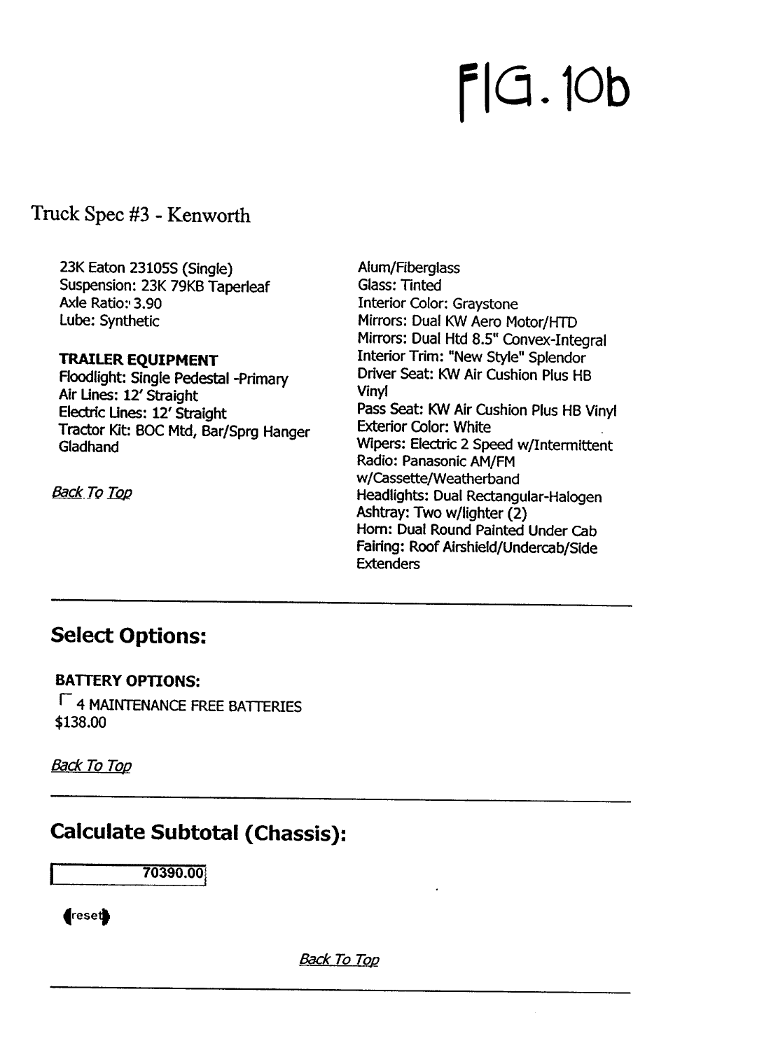

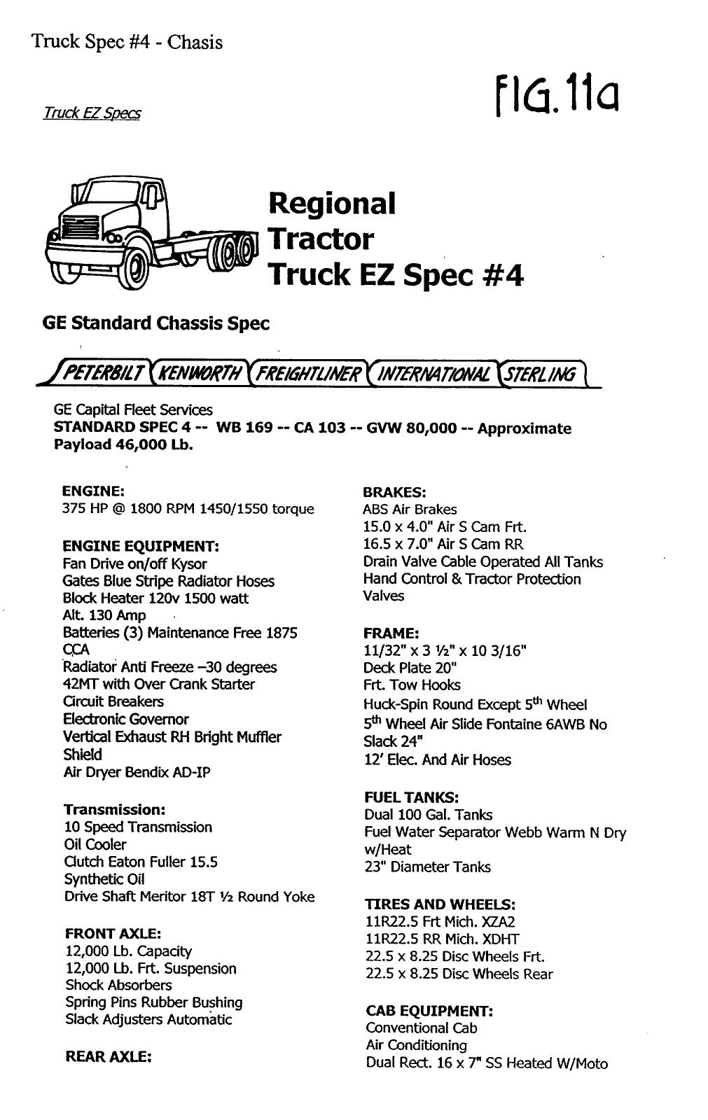

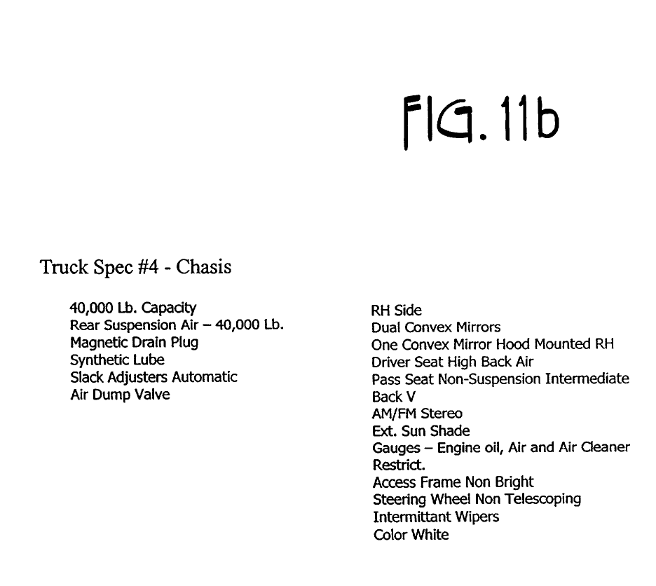

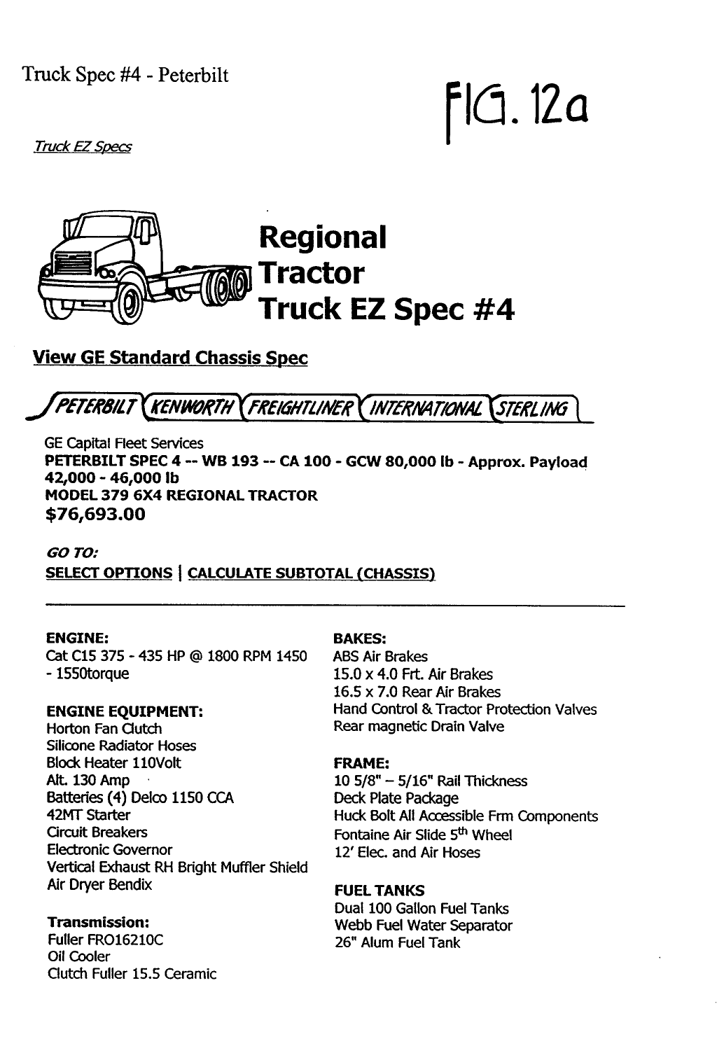

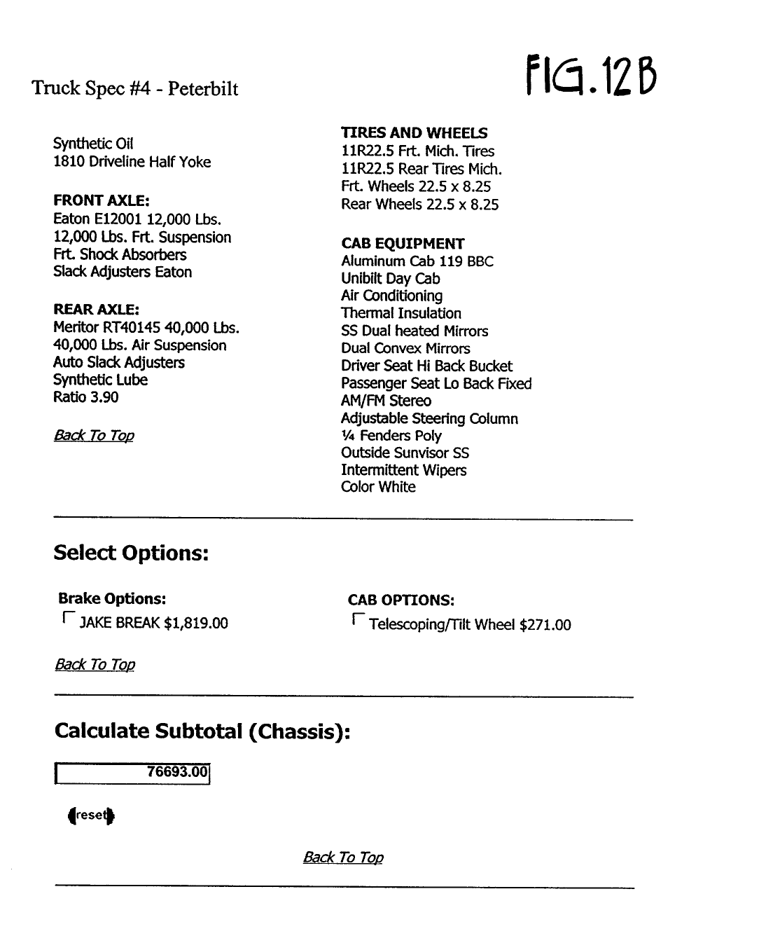

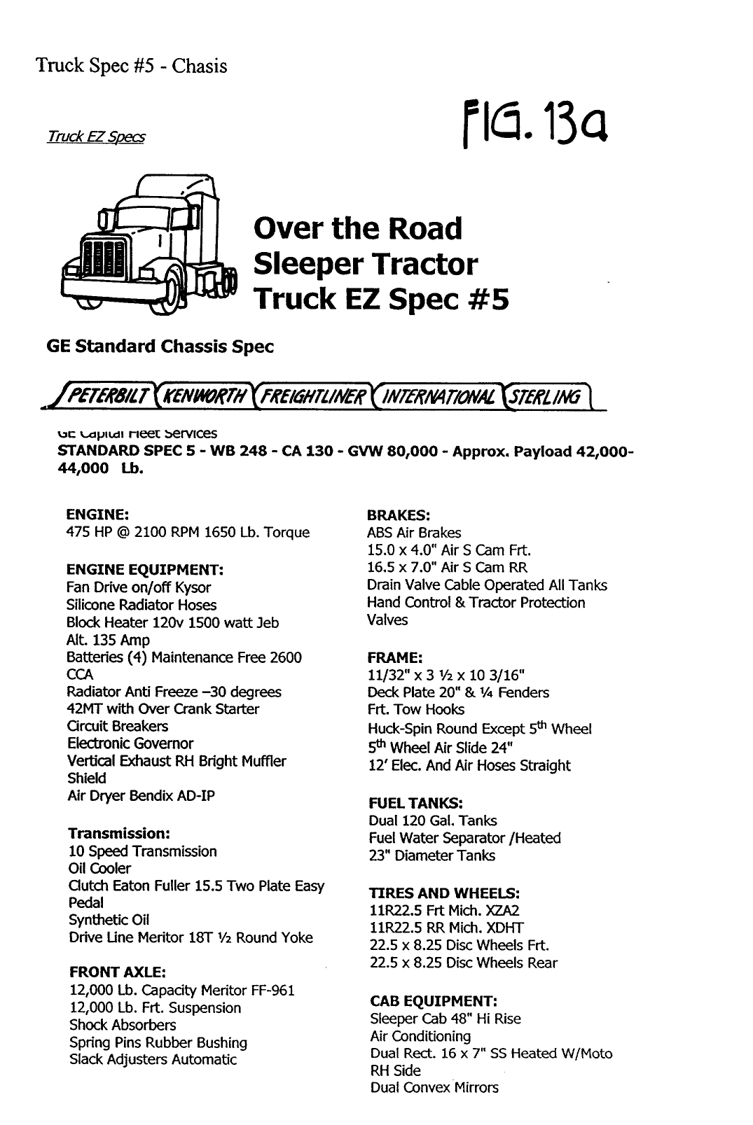

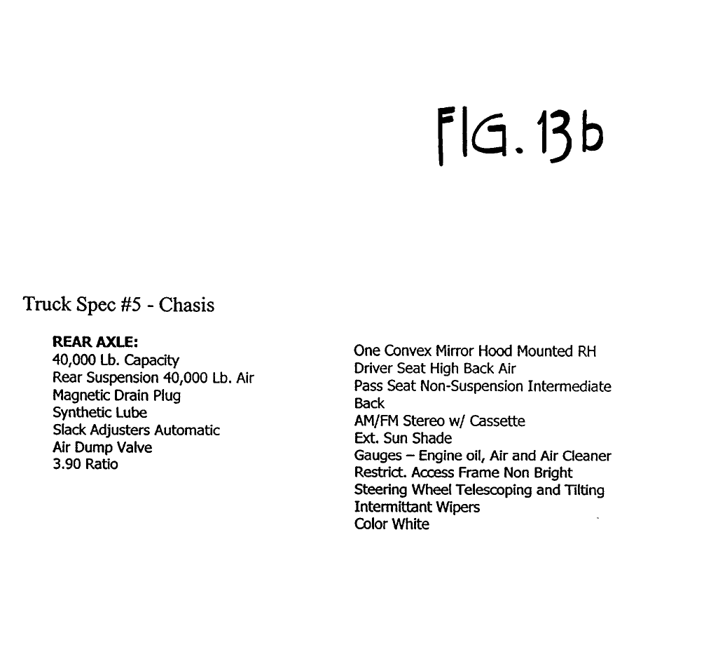

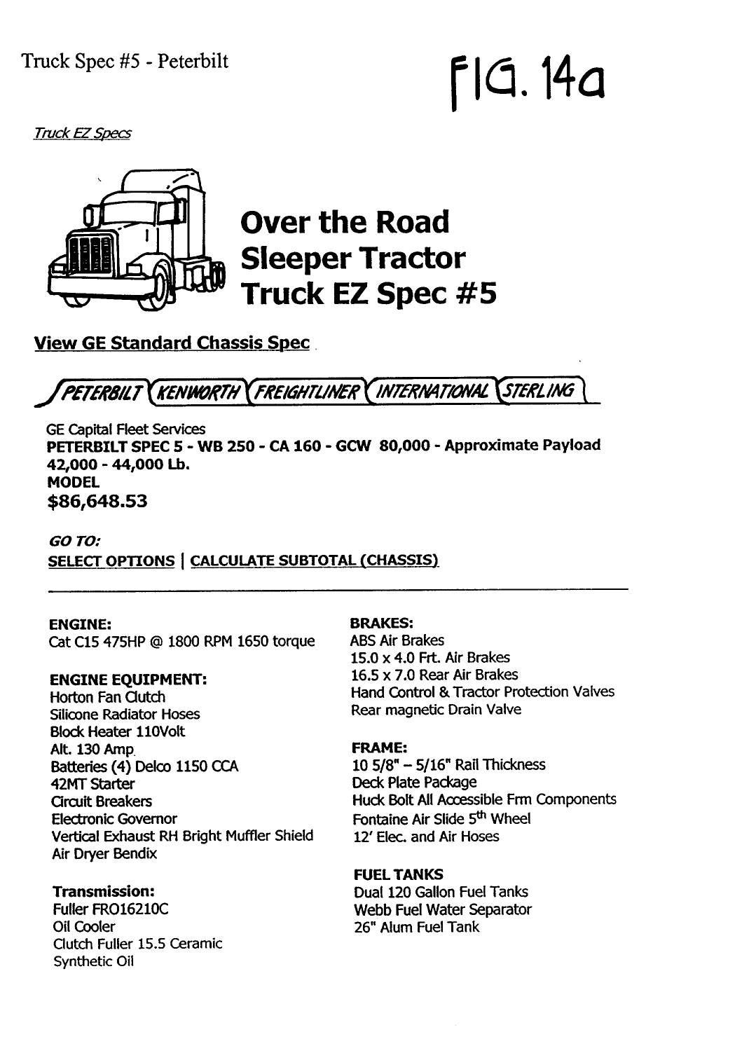

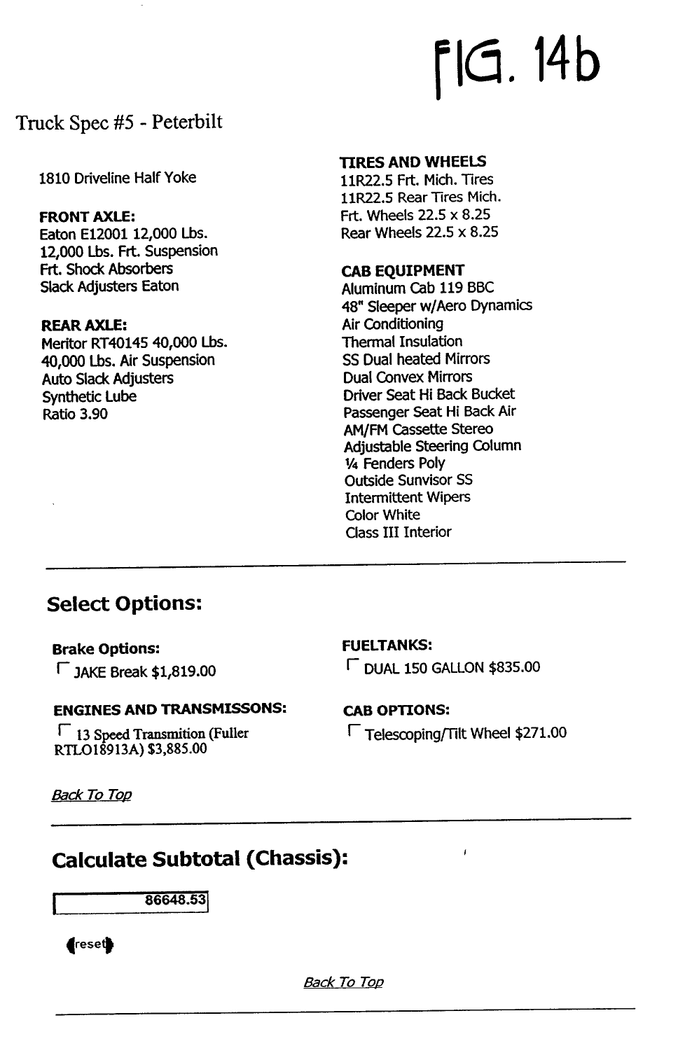

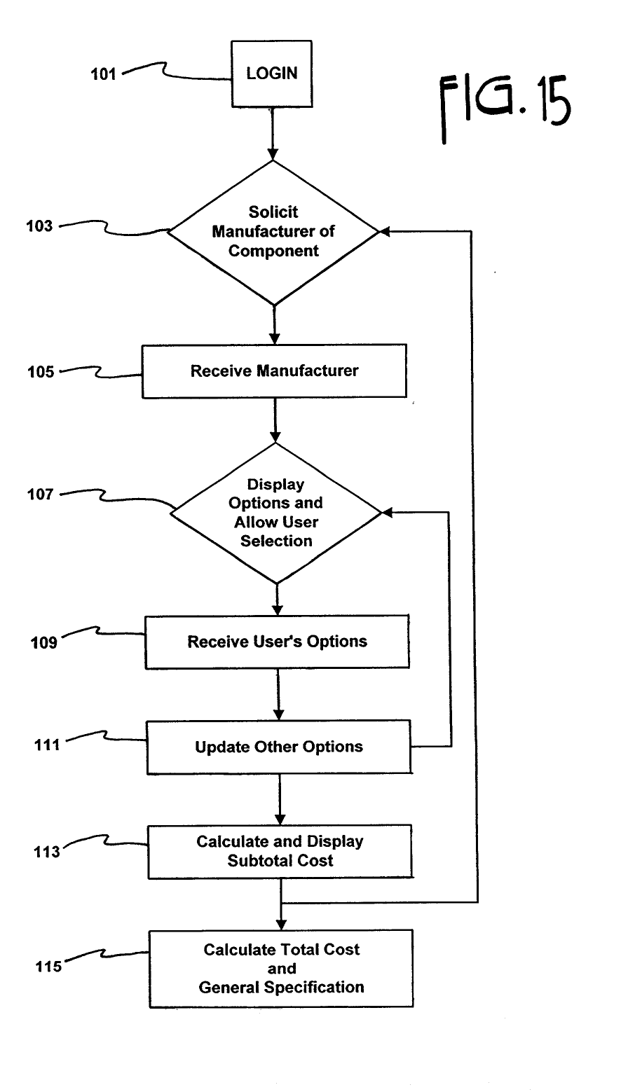

FIGS. 3-14 depict embodiments of various web pages that may be used in embodiments of the present invention that utilize the WWW. FIG. 15 depicts a flow chart of the operation of one embodiment of the invention. In alternative embodiments, including interactive voice response embodiments, other information communication techniques may also be used within the scope of the invention. The systems and methods of the invention may use common database functions to sort and recognize different dealers, salespeople and customers. The present embodiment system may be set up so that it is only utilized by the salespeople associated with the system proprietor. In alternative embodiments, the system of the present invention may be likewise accessible by customers at their leisure to inspect the pre-engineered specifications, or, in alternative embodiments, to actually select options and generate a quote. In still further embodiments customers can access the present invention system and learn the manufacturing dates of the trucks they have ordered.

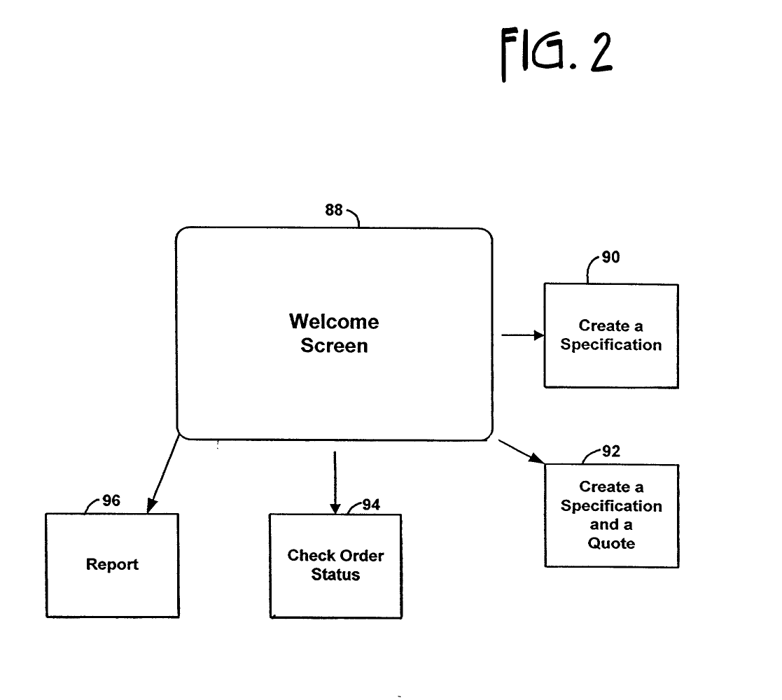

FIG. 15 begins with a login procedure 101, which represents the possibility that the system of the invention may contain a firewall 18 (FIG. 1) or other password control features to prohibit unauthorized personnel from entering the system. Password control may also be used to restrict access to certain dealers. Furthermore, certain system administrators may have access to the programs of the invention to manipulate formulas, rates, or options used in the calculations of the invention. The login procedure may indicate to the present invention what areas of the present invention the user may be allowed access. After a user logs onto the system, the user may be presented with a welcome screen, main menu, or other user friendly program. From this screen, the user may select the desired option the user wishes to perform. As illustrated in FIG. 2, the present invention may include a welcome screen 88 that allows the user to create a specification for equipment 90, to create a specification and generate a quote for equipment 92, to check the order status for ordered equipment 94, or to run a report 96. As may be appreciated, the username and password may indicate to the present invention system some of the options that may be selectable by a given user.

1. Displaying Options and Prices

As illustrated in FIG. 15, after a user, typically a salesperson or dealer, logs into the system, the user may select what type of equipment for which the user wishes to generate a quote. In the present embodiment, the user may select what type of truck for which the user wishes to generate a specification and a quote from a pre-engineered specification; for example, the user may select from a medium duty truck, a heavy duty truck, trucks of various weight, a city tractor, a regional tractor, or a sleeper tractor. FIG. 3 illustrates the selection of the medium duty truck specification#1. As will be further illustrated herein, each of these pre-engineered specifications, such as is illustrated in FIGS. 3, 7a, 9a, 11 a, and 13a, may contain information that approximates the characteristics of a truck in that class. Each manufacturer may then have a variety of components to build, manufacturers that make those components, and/or options for specific elements of the leased equipment. In alternative embodiments, the user may be able to select from a greater or fewer number of equipment options without changing the nature and scope of the present invention.

When using the present invention system and method, the standard specifications may give the approximate size, weight, capacity, etc., for each truck class, thus allowing the customer to easily evaluate what general class of chassis in which the user may be interested. The web page of FIG. 3 may depict a standard specification for a certain type of truck chassis. In FIG. 3, for example, the standard specification has a 210 HP engine and hydraulic anti-lock brakes, in addition to numerous other options as depicted. Once the user has selected a truck class, the user may then select a component of the truck to build. As illustrated in FIG. 3, the present embodiment allows the user to build, from standard pre-engineered specifications, a truck chassis or a truck body. Although the chassis may typically be designed before the body, and therefore the order of building the components may matter, in other embodiments of the invention the components of the equipment may be built in any order. The customer may then select a manufacturer of the chassis and review the pre-engineered specification for that particular manufacturer and the types of options the manufacturer makes available.

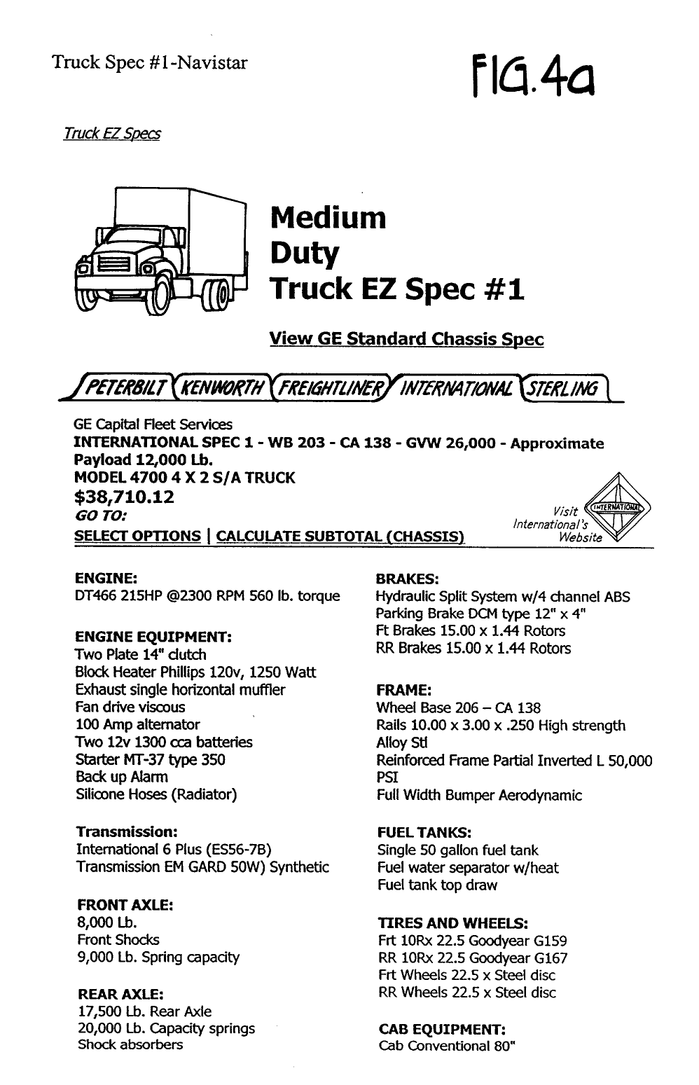

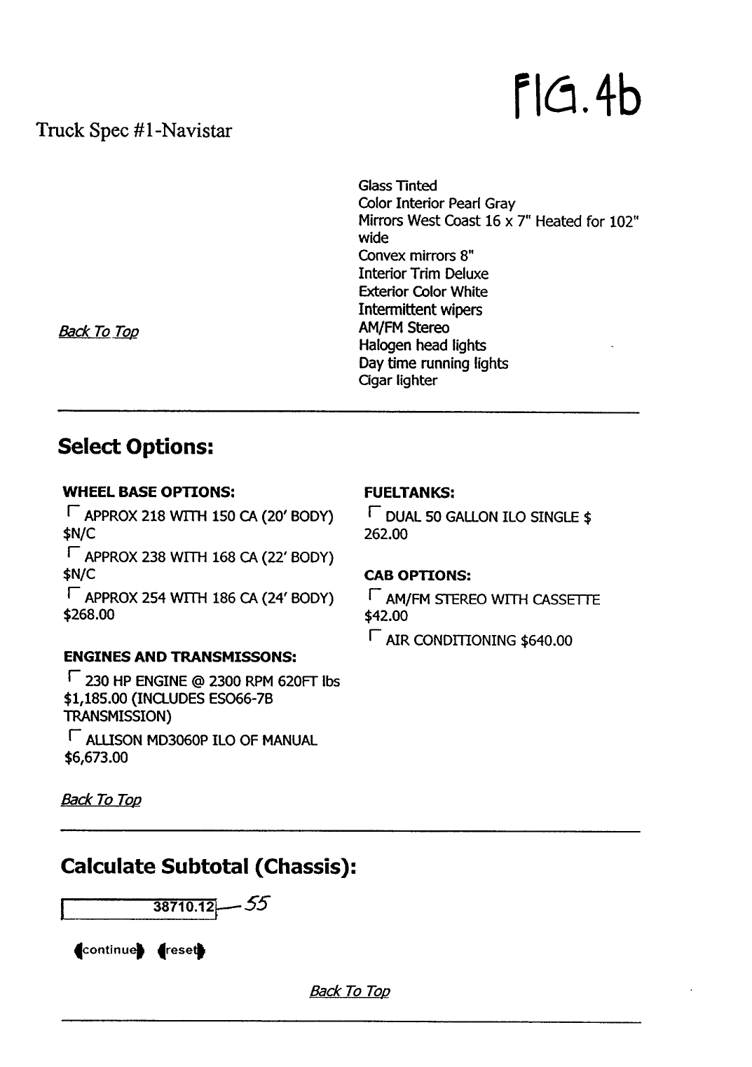

The user may select a manufacturer by clicking on the tab bearing the name of the desired manufacturer. See FIG. 15, block 105. After the tab has been selected, the server 10 may then send the HTML page bearing the requested information to the client for display to the user. FIG. 4a illustrates the selection of the chassis as the component to be designed and International as the manufacturer of the chassis. Other manufacturers may also be listed in any manner known to those skilled in the art for user selection. FIG. 4a, for instance, shows General Motors, Ford, Freightliner, International, and Sterling as manufacturers of the chassis component of the truck. As illustrated in FIGS. 4a and 4b, upon the selection of a particular manufacturer, a standard, pre-engineered specification for that manufacturer's component may then be displayed on the client computer for review by the user. (The standard specification and the options listed may be shown using the manufacturer's terminology) The user may review each of the different manufacturer's pre-engineered specifications for selection of the one that best fits the customers need. The salesperson may help the customer in this regard and utilize the present invention to facilitate the quick selection of the pre-engineered specification that most fits the customer's needs. As illustrated in FIG. 4a-4b, the individual manufacturer's pre-engineered specification is not the same as the system proprietor specification illustrated in FIG. 3; as previously mentioned, the system proprietor's pre-engineered specification is useful to indicate the type of equipment (in this case, the chassis) which may be found under that class, but instead may only approximate the manufacturer's actual specifications. The specification illustrated in FIG. 3 has a 210 horsepower engine that has a certain torque at a certain rpm, certain axle specs, etcetera. The specific manufacturer's specifications may be slightly different; FIG. 4a illustrates a 215 HP engine at a certain torque and rpm. Once the manufacturer's preengineered specification for the chassis is selected, the customer, working with the salesperson, may then choose as many or few options as the customer desires and the manufacturer allows.

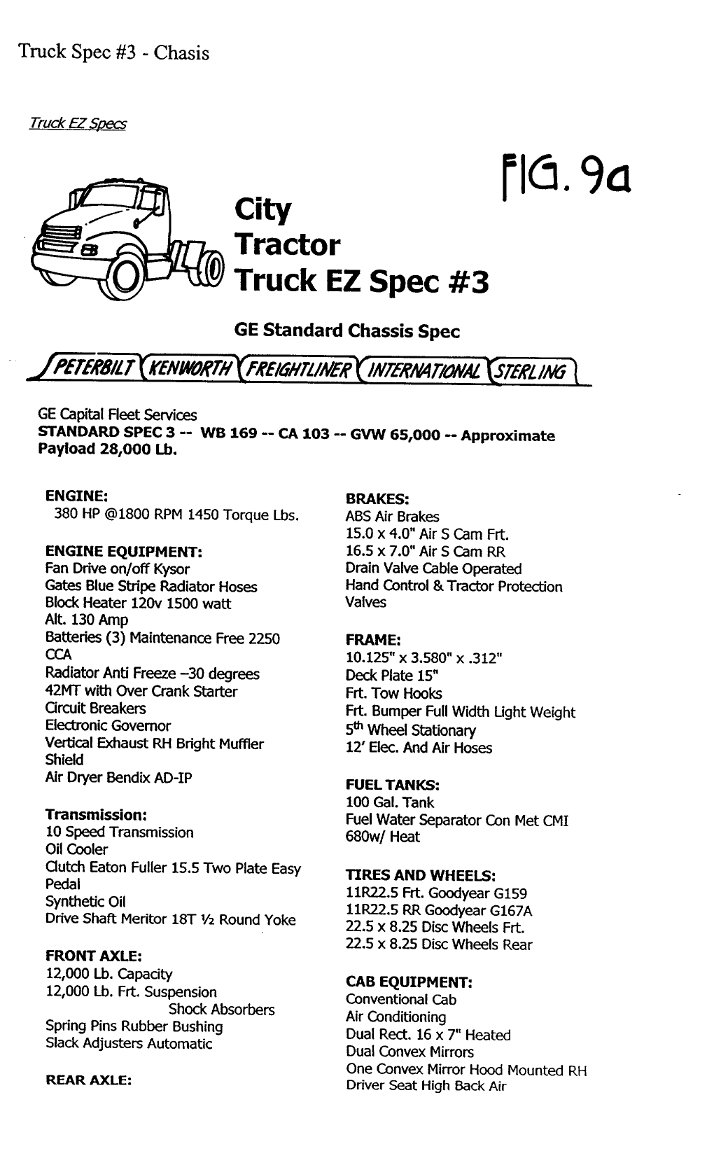

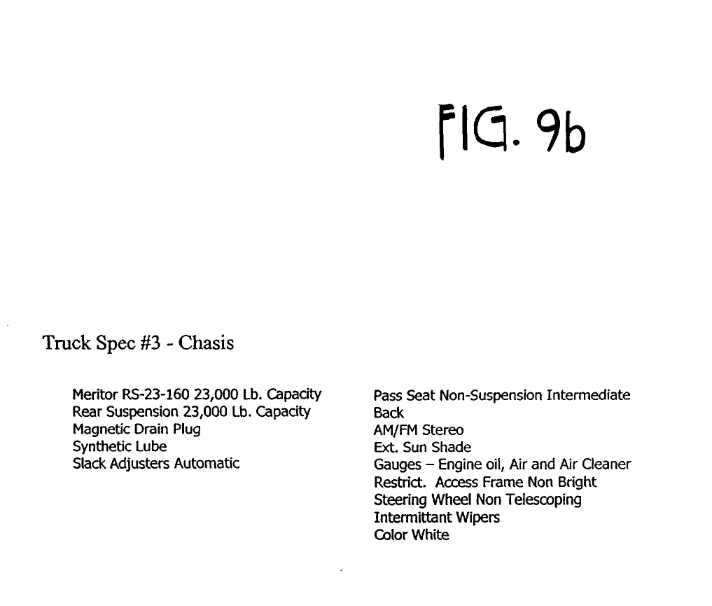

After selection of the manufacturer of the chassis, a number of design options may then be presented to the user and the user may select from those options in order to modify the pre-engineered specification into a custom specification of the leased truck component. FIG. 15 depicts this act as blocks 107 and 109. FIG. 4b depicts a continuation of the web page of FIG. 4a in which a number of options are presented to the user for selection. Any number of options in any area for the design of the leased equipment may be presented in a format such as that of FIG. 4b. Each option may, in one embodiment, may display a price which represents the actual or typical cost of selecting that option in the specification. Some option prices, however, may not have a set price because the price for one option may depend on the selection of other interrelated options. After each option is selected, a subtotal may be calculated or updated, as shown in block 111 of FIG. 9 and described more fully in the following section.

The options depicted in FIG. 4b may be additional options to the standard specification or, in other embodiments, options that replace portions of the pre-engineered specification. Each manufacturer may allow for a different number and variety of options. Some manufacturers may allow options, including, for example, engines, transmissions, axles, brakes, etcetera. The system proprietor may also limit the number and types of options that are available to each customer in order to facilitate the customer's selection of the pre-engineered equipment and modification of the same. The system proprietor may wish to have a number of pre-engineered specifications that will meet almost any potential customer's need, thus limiting the time required for the salesperson to work with each customer to select options. Reducing the time the salesperson spends with each customer in this manner may allow the salesperson time for more customer contacts, quicker quote generation for each customer, and thus more sales.

In some embodiments of the invention, the options from which a user may select may be limited. In other embodiments, however, a larger number of options may exist from which the user may choose. In an embodiment with a limited number of available options, a large number, perhaps even a majority, of the options for the equipment may be pre-engineered. Such a pre-engineered specification may be one designed to perform certain functions, such as, for a truck, certain towing capacity. The databases 34 of the server 10, therefore, may contain a large number of pre-engineered or standard specifications designed to meet a wide range of customer needs. Pre-engineered specifications and options allow the user, through the selection of options, to build a specification having a number of different customized pieces, elements, or options. In this embodiment, therefore, through selection of given options, the user may effectually deviate from the pre-engineered specification selected or the user may add further options to such a pre-engineered specification for the leased truck.

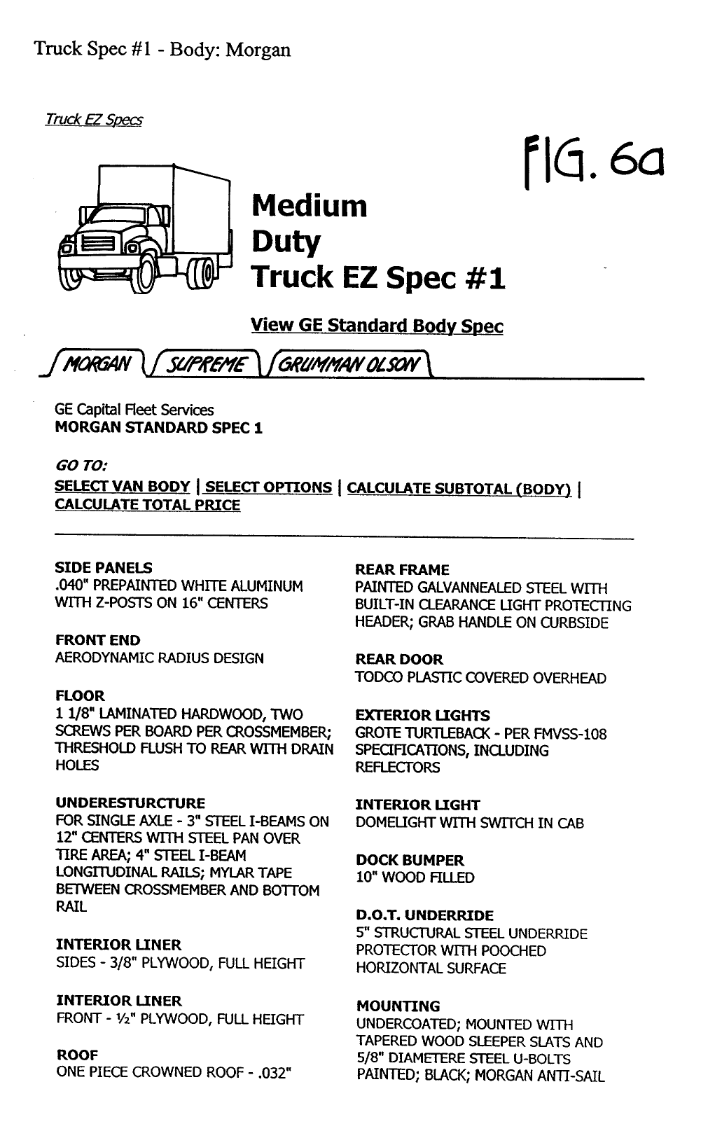

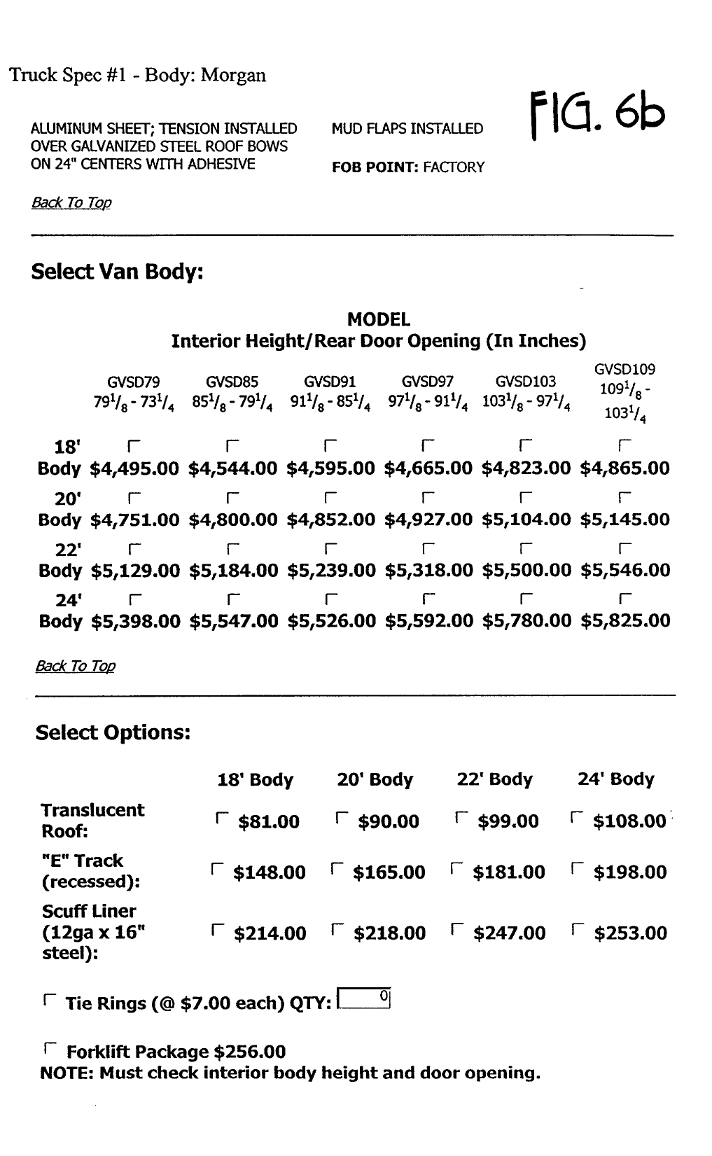

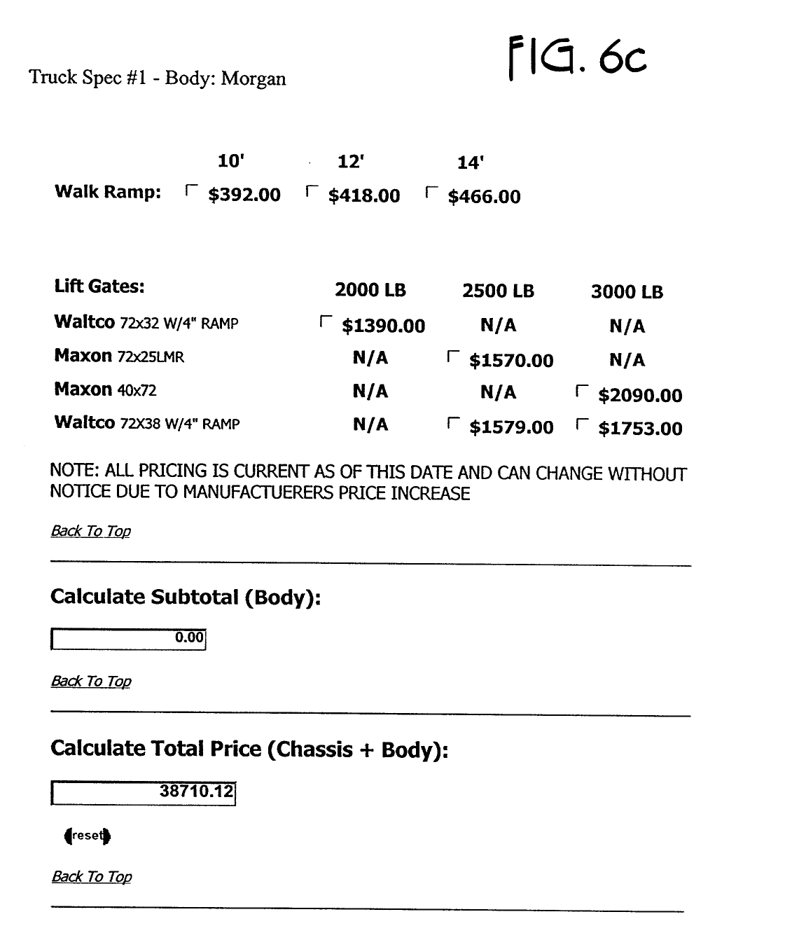

As previously mentioned, some equipment, such as a truck, may have a number of options available to the customer. Each option, however, may not be compatible with other options. Because certain components of the specification may be interrelated, the selection of one option for a component may require that other options be selected or, in some cases, deselected. Certain options, for instance, may be incompatible with other options or may be compatible only if yet another option is selected. Interrelated options may exist within the same component or may be options in a different component that are only compatible with certain options in the first component. For example, in FIG. 4b, the selection of one wheel base option would cause the automatic selection of a certain bod length and or could make the selection of other bodies impossible. The selection of a given wheel base option may cause the automatic selection of a given van body length (FIG. 6b) and make it impossible to select other van body lengths. After one option has been selected, the user may change other options or select further options to build the specification, as indicated by the arrow of FIG. 15 between blocks 111 and 107.

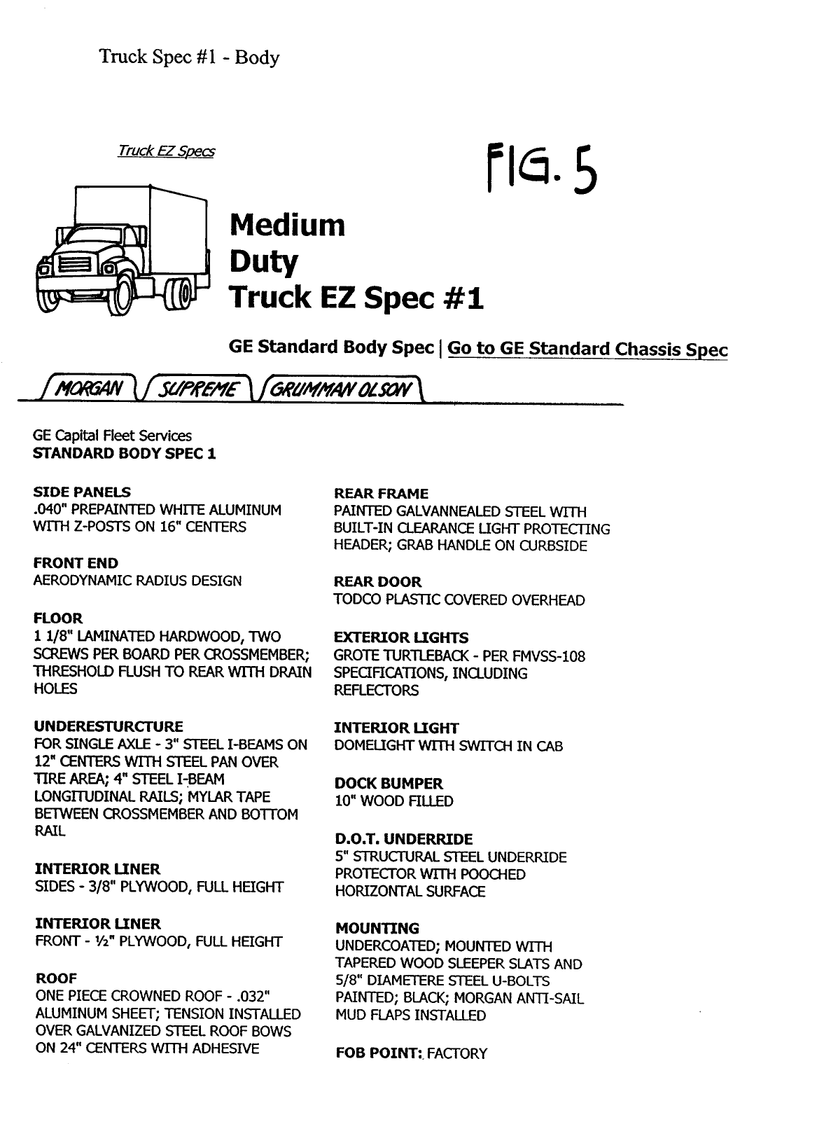

After a first component has been selected, and the options have been reviewed and selected to modify the pre-engineered specification, the above procedure may be repeated for other components of the leased truck, as depicted by the arrow of FIG. 15 between block 113 and block 103. FIGS. 5 through 6c depict web pages that may be used for the design of the body of a truck (a second component). In this embodiment, the body of the truck may be designed after the chassis of the truck has been designed. It should be noted, however, that certain options of the second component (the truck body) may already be automatically selected or may not be selected depending on the configuration of the first component (the truck chassis). Much like for the truck chassis, FIG. 5 depicts the possibility that a number of manufacturers of truck bodies may be selected in the configuration process. In the present embodiment one manufacturer should be selected, thereafter the options should be selected, and thus the truck specification is completed and ready for ordering.

After each component has been configured, a total cost for the lease may be generated for the modified pre-engineered specification. In addition, a report detailing the completed specification may be displayed. FIG. 15 depicts these acts as block 115. In FIG. 4b, for instance, the subtotal body quote 55 may be updated after each option is selected, or may be updated upon the completion of the design of the given component. In FIGS. 4a and 4b, for example, after the user has completed the option selection for the chassis of a truck, the subtotal cost 55 for the given chassis may be displayed. FIG. 15 depicts this act as block 113. FIG. 6c, which shows a subtotal calculation for the body of a truck, also shows the total price for the configured truck consisting of the chassis and the body. The total price may, in one embodiment, be a firm, set price based on the prices of the specifications and options selected. In other embodiments, the total price may be a general guideline price that may change depending on the current prices of options charged by manufacturers. In the latter case, customer selects the pre-engineered specification, selects the desired options, and then is presented with an approximate price for the vehicle and in the future provided with the monthly lease payment options. The approximate price may be based on the numbers provided by the manufacturer's past prices and specifications, or may be an average of the industry for that type of equipment. Once the customer has selected the specification and options that the customer wants to purchase or lease from the approximate price quotes, the customer is then presented with an updated and accurate final price from the salesperson. The salesperson may obtain the lease quote directly from the manufacturer, or, in alternative embodiments, may utilize updated pricing sheets that are not yet inputted into the present invention system.

After a total lease price and a completed specification have been assembled, the potential customer can decide to complete a purchase order or seek a quote on a different design for the leased truck. In one embodiment, the purchase order may be submitted to the server 10 electronically, which could reduce the paperwork involved in the transaction.

2. Generating Subtotal Information and Reports

As illustrated in FIG. 2, the system and method of the present invention may also be used to generate a variety of reports that may prove useful for system proprietors, salespeople or customers. Statistics may be generated showing the number of closed transactions per quote generated for a given dealer or a given salesperson. Because, in one embodiment of the invention, dealers or salespersons may be required to log into the system, statistics may be kept showing the number of leases or sales closed, the types of leases or sales closed, and the number of lease or sales quotes and configurations generated for the salesperson or dealer. These statistics may be easily compiled by referencing a specific user identification name or number. The efficiency of the salesperson may therefore be readily determined. In addition, market research may be conducted as to the types of equipment or embodiments of equipment that are best or worst sellers. A number of reports regarding customers may also be generated within the scope of the invention. For instance, purchasing habits of customers may be automatically generated. In addition, purchase cycle times that indicate the purchasing trends of a customer by the time of year, such as the spring or winter, may be generated. In addition, purchasing volume reports may be generated that indicate the make, model, year, and typical designs for a given customer, as well as the quantity of given designs leased or sold. Component trends may also be determined, such as which options are most frequently chosen and which are fading in popularity. These reports may aid the system proprietor in designing efficient business processes.

After generation of a specification and a quote, links in the web pages of some embodiments of the invention may be used to link to manufacturer web pages, industry links, or other links that may provide further information about equipment designs. In one embodiment, through the use of manufacturer hyperlinks, a salesperson or customer may be able to check on an order status or determine if certain components for leased equipment are out of stock with a given manufacturer. Some manufacturers also have on-line locator services that may provide information on locations throughout a given state or country in which one or more components of the equipment may be located. Such links may aid in designing a specification or altering a given design so that quick delivery may be possible. Projected manufacture delivery times for equipment may also be quickly obtained using such links. In addition, advertisements for certain manufacturers may appear on some of the web pages of the invention.

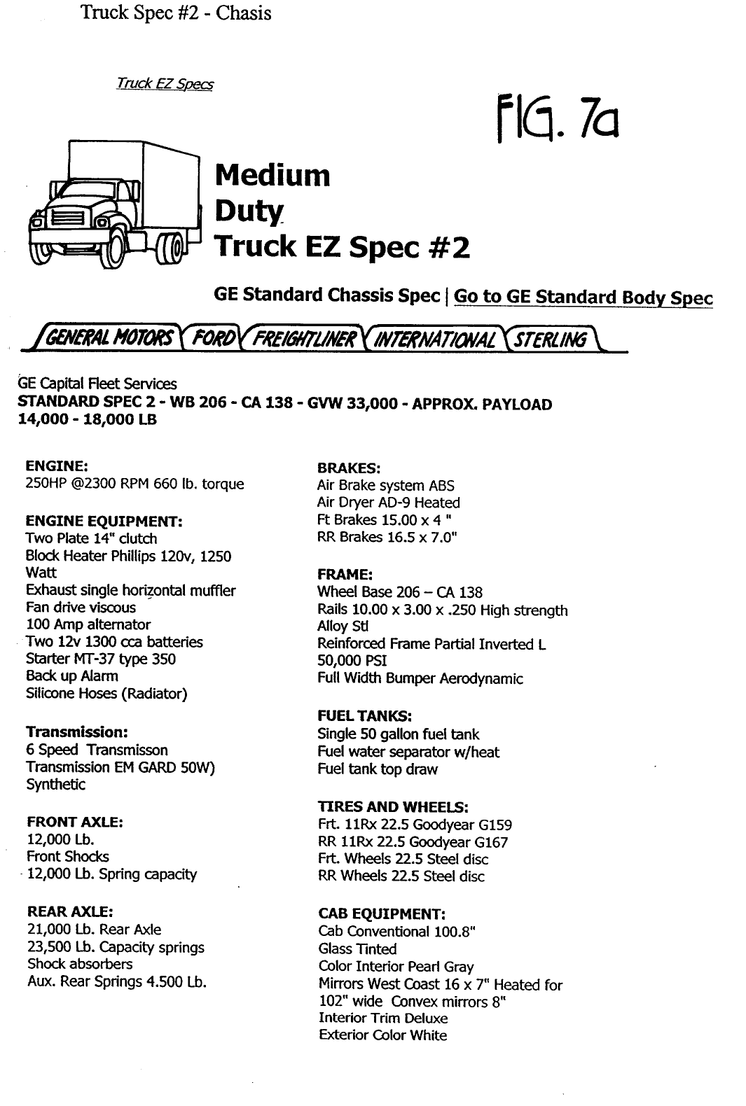

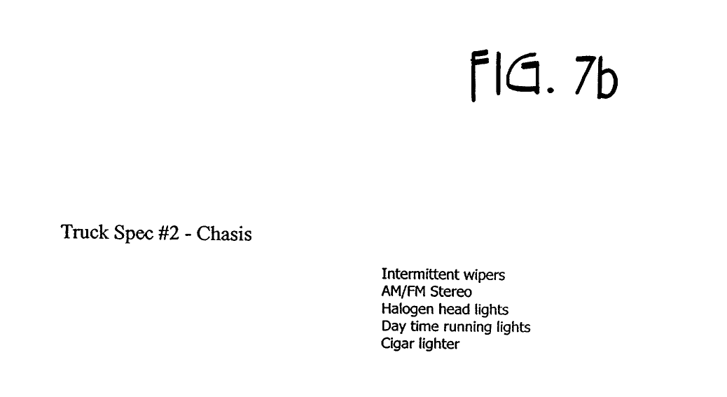

FIGS. 7a through 14b display alternative pre-engineered specifications for different truck sizes, in addition to selectable options for the first component of the truck that may be purchased. Each one of these displays one or more pages of standardized pre-configured specifications for the trucks size. If a customer desires to purchase or lease a truck of this size, the customer may select the pre-configured truck chassis that most fits with the customers need, may then select a manufacturer of the first component (the chassis) and then select a manufacturer of the second component (the body). For both the first component and the second component the customer may also choose to select a number of options that are selectable according to the chosen manufacturer. As may be appreciated, the steps by which the pre-configured specification, the first and second component manufacturers, including the options, may be substantially similar to those described above for FIGS. 3-6c. As may be further appreciated, the advantages present for the selection of the same may also be true for these alternative first and second component selections.

The method and system of the invention provide numerous advantages over previous method and system for modify pre-engineered specifications to generate quotes. Sales personnel can use the method and system of the invention to quickly generate specifications and quotes for potential customers. Instead of having to wait several days to receive a detailed specification and quote for the equipment, the potential customer can be presented with a specification and quote within a single visit to a salesperson, perhaps in a matter of seconds or minutes. Not only does this increase convenience for the salesperson and the potential customer, but it may make it more likely for the customer to lease or purchase the equipment. If, for example, the user wishes to build a truck with a chassis having a 230 HP diesel engine, automatic transmission, and an optional wheel base, along with a body that may accommodate a forklift and has a reinforced floor, the user may quickly and easily build such a package and acquire the specification or approximate cost. The cycle time for generating a quote and specification, therefore, may be significantly reduced through use of the invention, and the customer may be more inclined to purchase or lease after a shorter amount of time invested by the salesperson.

The systems and methods of the invention also provide the advantage of ensuring the viability of a specification and a quote before it is shown to a potential customer. If a salesperson or an engineer generate a specification and quote, numerous possibilities exist for human error. The methods and systems of the invention, on the other hand, ensure that a specification and a quote will be viable because only viable specifications can be designed. The deselection of non-compatible options insures the accurate modification of the pre-engineered specifications. This reduction of the possibility of human error may give potential customers greater confidence in a salesperson or a dealer and may increase the number of sales.

A further benefit of the method and system of the invention is that records may be easily generated and kept regarding the performance of sales personnel and the buying patterns of customers. It may be easy to determine the number of leases or sales closed per quote request for a given salesperson or a given dealer. Overall statistics regarding performance and efficiency for an aggregate number of sales personnel may also be developed. In addition, the methods and systems of the invention may allow sales personnel or a lessor to easily determine the buying patterns of individual customers.

Yet another benefit of the methods and systems of the invention is that the links from the web pages of the invention to on-line manufacturer or industry sites may be used to determine the approximate delivery time for equipment or to determine whether desired equipment or components thereof are readily available. These links may also be used by the salesperson to insure questions about designs, specifications, and prices may be easily and quickly answered, oftentimes during the time when the salesperson is in contact with the customer on a real time basis. The ability to quickly and easily access information in this manner may improve the customers satisfaction with the salesperson and result in quicker or greater sales.

Yet another advantage to the method and system of the present invention is the ability of the customer to select as many or as few pre-engineered available options as the customer desires. The customer can work with the salesperson to quickly select a pre-engineered specification that will meet the needs of the customer and that can be quickly delivered, or the customer and the salesperson can spend a longer time selecting from a variety of manufacturers of different portions of the equipment, including the chassis and the body, and options available from different manufacturers, to arrive at a piece of equipment that is highly specialized for that customer's particular use.

Yet another advantage includes the ability for the customer and/or salesperson to receive an order number, thereafter utilizing an order number to track down the build date of the various selected components. Knowing the approximate build date will allow a customer to better plan regarding the delivery time schedule of the ordered equipment. Furthermore, if one component is set to be built at a different time than another component, the salesperson can attempt bring the two dates closer together so that the built component does not sit waiting for the other component to be built.

Another advantage to the present invention is the ability of the present invention to free up salespeople's time so that more time can be spent with direct customer contact. As may be appreciated, more customer contact may result in more overall sales.

While the present invention has been described with reference to several embodiments thereof, those skilled in the art will recognize various changes that may be made without departing from the spirit and scope of the claimed invention. Accordingly, this invention is not limited to what is shown in the drawings and described in the specification but only as indicated in the appended claims, nor is the claimed invention limited in applicability to one type of computer or computer network. Any numbering or ordering of elements in the following claims is merely for convenience and is not intended to suggest that the ordering of the elements of the claims has any particular significance other than that expressed by the language of the claims.

What is claimed is:

1. A method for building a quote for a piece of equipment comprising:
(a) displaying one or more pre-engineered specifications for the equipment;
(b) electronically soliciting from a user a selection of one pre-engineered specification;
(c) soliciting from the user a selection of a manufacturer of a first component of the pre-engineered specification;
(d) displaying options and prices for the first component and allowing the user to select one or more options for the same, the act of displaying options and prices including updating the displayed options and prices after an interrelated option has been selected; and
(e) generating a report showing the options selected for the first component and a subtotal cost for the component.

2. The method of claim 1, further comprising repeating acts (c) through (e) for a second component.

3. The method of claim 1 further comprising generating a report showing the components selected and the cost of the first component, the second component, and the total cost of the equipment.

4. The method of claim 1 wherein displaying the pre-engineered specification includes displaying an approximate price for that pre-engineered specification.

5. The method of claim 1 wherein displaying options and prices for the first component includes displaying those options that are available from the selected manufacturer.

6. The method of claim 3 wherein the quote is for a lease.

7. The method of claim 3 wherein the quote is for a purchase.

8. A method for building a specification for a truck comprising:
electronically soliciting from a user a selection for a truck class;
soliciting from the user a manufacturer of a pre-engineered chassis of the truck;
displaying chassis options and prices for the chassis and allowing the user to select one or more chassis options, the act of displaying chassis options and prices including updating the displayed chassis options and prices after an interrelated chassis option has been selected;
soliciting from the user a manufacturer of a pre-engineered body of the truck;
displaying body options and prices for the body and allowing the user to select one or more body options, the act of displaying body options and prices including updating the displayed body options and prices after an interrelated body option has been selected; and
generating a report showing the chassis options selected, the body options selected, and a total cost for the truck.

9. The method of claim 8 wherein the chassis options include one or more of the group consisting of wheel base options, engine options, and transmissions options.

10. The method of claim 9 wherein the chassis options include one or more of the group consisting of fuel tank options and cab options.

11. The method of claim 12 wherein the body options include van body size options.

12. The method of claim 11 wherein the body options include one or more of the group consisting of roof options, cargo control options and interior liner options.

13. The method of claim 9 further comprising displaying chassis options and prices, including displaying a subtotal price for the chassis.

14. The method of claim 9 further comprising displaying body options and prices, including displaying a subtotal price for the body.

15. A method of doing business for generating quotes for leased equipment, the method comprising:
electronically storing an at least one pre-engineered specification for a piece of equipment on a server;
allowing access to the stored specifications by a user;
electronically soliciting from the user a selection of one specification stored on the server;
displaying to the user one or more options relating to the selected specification;
receiving from the user one or more selected options;
updating the one or more options after each of the one or more options is selected by the user; and
displaying to the user a price quote for the selected specification and the selected options.

16. The method of claim 15 further comprising displaying specifications relating to one or more manufacturers of the piece of equipment.

17. The method of claim 16 further comprising displaying a link to a server wherein information from the manufacturer may be accessed.
